(19) United States
(12) Patent Application Publication
(10) Pub. No.: US 2012/0006804 A1
(43) Pub. Date: Jan. 12, 2012

(54) Electrically Heated Push Device for Clearing Accumulated Snow and Ice

(76) Inventor: Karen Lea Jenkins, Indianapolis, IN (US)

(21) Appl. No.: 13/177,678

(22) Filed: Jul. 7, 2011

Related U.S. Application Data
(60) Provisional application No. 61/362,760, filed on Jul. 9, 2010.

(51) Int. Cl. H05B 1/00

(52) U.S. Cl. 219/202

(57) ABSTRACT

An electrically heated snow and ice melting device for use clearing pathways along sidewalks, up stairs and along driveways. The device comprises a push-style cart with a wheel-mounted frame, an extendable push handle and an internal, electrically heated plate that mounts along the base of the frame. The height of the frame is controlled by each wheel height adjustment track on the corners of the frame, while power is provided to the heated plate via an onboard power supply and electronics for controlling temperature and power distribution. Power can also be provided through an extension cord, which allows the device to operate without consuming battery power within a given distance from an outlet. The height of the plate, the mode of heat transfer and the height of the device allow the user to rapidly melt and evaporate snow, ice and moisture along a pathway.

### CROSS REFERENCE TO RELATED APPLICATION

This application claims the benefit of U.S. Provisional Application No. 61/362,760 filed on Jul. 9, 2010, entitled “Liquid Snow Machine.”

### BACKGROUND OF THE INVENTION

1. Field of the Invention

The present invention relates to ice and snow melting devices that eliminate the need for a user to shovel or otherwise carry and clear a pathway after an accumulation of the same. More specifically, the present invention pertains to an electrically heated device that employs a push cart-mounted hot plate and onboard power for introducing a heat source over snow and ice for rapidly clearing a pathway without undue strain on the user.

2. Description of the Prior Art

Cold weather seasons, and particularly those areas in colder climates, experience accumulation of snow and ice along areas of traffic that pose a safety hazard if left unchecked or uncleared. Overnight snowfall and ice accumulation can make for hazardous conditions for individuals attempting to reach their car or exit their house in the morning. Typical removal techniques include manually shoveling and breaking up thick patches of snow and ice. This can be particularly burdensome for those with health concerns, the elderly and those with physical disabilities. Further, the amount of time and effort exerted while outdoors leaves individuals at risk for colds and other diseases, as the cold air and physical exertion can lower one's immune system.

Accumulated snow can become very heavy if not immediately cleared, and likewise can become wet or even hardened in moist conditions or in the presence of freezing rain. This further exacerbates an individual's ability to physically clear a pathway or large areas of fallen snow. Alternative methods include use of a snow blower, which is typically a gas driven device that accepts and jettisons snow a given distance for the purpose of clearing a given area. This device may be useful in most wintery situations, but it is typically very loud during use, it can be difficult and dangerous to handle and it is not always effective in icy or hardened snow conditions.

After a pathway is sufficiently cleared of accumulated snow, a user typically lays down a bed of rock salt to prevent ice formation on the cleared path. At extremely low temperatures, typically below 20 degrees Fahrenheit, rock salt is ineffective at melting ice. Ice formation along a section of sidewalk, steps or driveway precipitates the use of further precautions and additional tools to clear the ice in these extremely low temperatures.

The present invention provides a solution to clearing both accumulated snow and ice from pathways without resorting to laborious means or difficult to wield devices that are not always effective, the device also provides a tool to improve the effectiveness of rock salt and melt sections of ice. The device is useful for directly applying heat to a surface containing accumulated snow or ice in such a manner as to initiate melting and evaporation thereof. The device is an electrically powered, push-driven heating device that can be moved over areas of snow and ice. It is useful for areas of high snow accumulation, as well as after snow removal for ice removal for continued maintenance without the need for alternative hand tools to break up ice and snow. The use of the device in conjunction with rock salt also improves the salt's effectiveness by locally raising the temperature in a focused area. Rock salt effectiveness rapidly increases as temperature increases, as the rock salt absorbs the heat and raises the temperature of the salt/ice solution for rapid melting.

Several devices have been described in the prior art for push-driven, electrically powered ice and snow melting devices; however these devices share similar drawbacks in their structure and design that limit their capability. The present invention provides a device that attempts to remedy the drawbacks of the prior art and to introduce a new device that fulfills a given need presented therein.

U.S. Pat. No. 5,948,299 to Scalia describes a snow melting device with a melting assembly comprising an electric heating element, a handle assembly and an extension cord for powering the heating element. The melting assembly includes an upper and a lower plate, with the upper plate comprising an insulative material and the lower plate comprising a porous protective plate. The porous plate eliminates the chances of a user inadvertently contacting the inner heating element. While this device is similar in spirit and intent, the structure of described device differs from the present invention. The lower, porous plate restricts the high intensity, direct contact heating required to rapidly melt accumulated snow of any non-negligible magnitude. The present invention provides a hot plate that is adjustable along a wheeled assembly to change its height for a given level of snow. Direct or very close proximity heat application with the layer of snow is ideal for rapid melting and evaporation.

U.S. Pat. No. 5,140,762 to Monson describes an apparatus for melting snow and ice that includes a hand propelled plurality of frames. The apparatus is supported by a set of wheels, while each frame includes a coil heating element for projecting heat downward onto the ground for melting snow. Each heating element is covered by plates for reflecting heat downward, increasing the intensity of the applied heat along the ground surface. The forward frame is hingeable to collapse the assembly into a smaller volume for storage. While this device describes a snow and ice melting apparatus, its sheer size and complexity raises concerns for its safety and suitability for the given task. Its large size is a drawback when compared to the present invention, which by contract is more user friendly and compact in design. The Monson patent includes coiled heating elements, which also differs from the present, wherein heating plates are utilized for melting snow and ice along a given path.

U.S. Published Patent Application No. 2002/0069560 to Smith describes a hand-propelled snow melting device. The device provides an electric plate heater for melting snow and ice while being propelled by a user from behind using a handle means. The electric heater is positioned within an enclosure with a portable power supply. The heating means comprises an elongated heating coil, as opposed to the present invention which utilizes a heating plate to generate uniform heat distribution across the bottom surface of the device.

U.S. Published Patent Application No. 2007/0220781 to Altizer describes a portable snow and ice melter with adjustable legs to melt varying depths of snow. The melter comprises an enclosure with an electrically powered heating unit and control circuitry. While device seems suited for static placement over large layers of snow for eventual melting, it is not ideal for continual movement and melting snow as the device is wheeled over a path of snow, such as along a walkway or driveway.

U.S. Pat. No. 5,867,926 to Schmitt describes a portable convection heater for removing snow and ice from a side walk. The heater comprises a wheeled handcart with extension cord and an enclosure for projecting heat downward on the sidewalk surface. An air blower is provided along with a plurality of heating coils to provide convective heat directed at the snow and ice for melting thereof. The enclosure is slideable to adjust the height above the ground surface. While this device provides a means to melt ice and snow using a hand cart means, the mode of heat transfer differs from the present invention. Particularly, the use of heater coils, a convection means and a housing to direct the heat downward differs from the use of heating surfaces and conductive heat transfer for melting purposes.

The present invention provides an oval heating plate base, a wheeled, push handle configuration and an onboard power supply for directly applying head to the surface below the heating plate. Various size heating plates and support structures allow for its use along driveways, sideways and on steps. Its structure substantially diverges in design elements from the prior art and consequently it is clear that there is a need in the art for an improvement to existing snow and ice melting devices that employ a wheeled heating means. In this regard the instant invention substantially fulfills these needs.

### SUMMARY OF THE INVENTION

In view of the foregoing disadvantages inherent in the known types of snow and ice melting devices now present in the prior art, the present invention provides a new push-driven heating plate with adjustable height and battery power, wherein the same can be utilized for providing convenience for the user when clearing pathways of snow and ice, and further facilitating ice melting in conjunction with rock salt.

It is therefore an object of the present invention to provide a new and improved snow and ice melting device that has all of the advantages of the prior art and none of the disadvantages.

It is therefore an object of the present invention to provide a frame that supports a heating plate along its underside, said heating plate is supported by a plurality of wheels that allow the user to roll the device along a pathway using a handle projecting from said frame.

Another object of the present invention is to provide a device that utilizes a flat heating plate that can be positioned directly on or just above a desired surface for melting accumulated snow and ice thereon.

Another object of the present invention is to provide an electrically heated device that is powered by on-board batteries, or by an extension chord in the event of a low battery supply.

Another object of the present invention is to provide a frame that is adjustable in height based on the positioning of a plurality of wheels along their respective corner attachment rails.

Yet another object of the present invention is to provide a compact, easy to use device that can be provided in a number of sizes to fit a given task. These include a large heating plate and frame for clearing large pathways and driveways, a medium sized heating plate and frame for clearing sidewalks, and finally a small heating plate and frame for use on steps and in small spaces.

Other objects, features and advantages of the present invention will become apparent from the following detailed description taken in conjunction with the accompanying drawings.

### BRIEF DESCRIPTIONS OF THE DRAWINGS

Although the characteristic features of the present invention will be particularly pointed out in the claims, the invention itself, and manner in which it may be made and used, may be better understood by referring to the following description taken in connection with the accompanying drawings.

FIG. 1 shows a perspective view of the present invention, including the push-driven frame and compact design thereof.

FIG. 2 shows an exploded side view of the present invention, including the frame, heating plate and top mounted access panel.

FIG. 3 shows the present invention in use, wherein a user is pushing the device along a pathway to clear accumulated snow and ice.

### DETAILED DESCRIPTION OF THE INVENTION

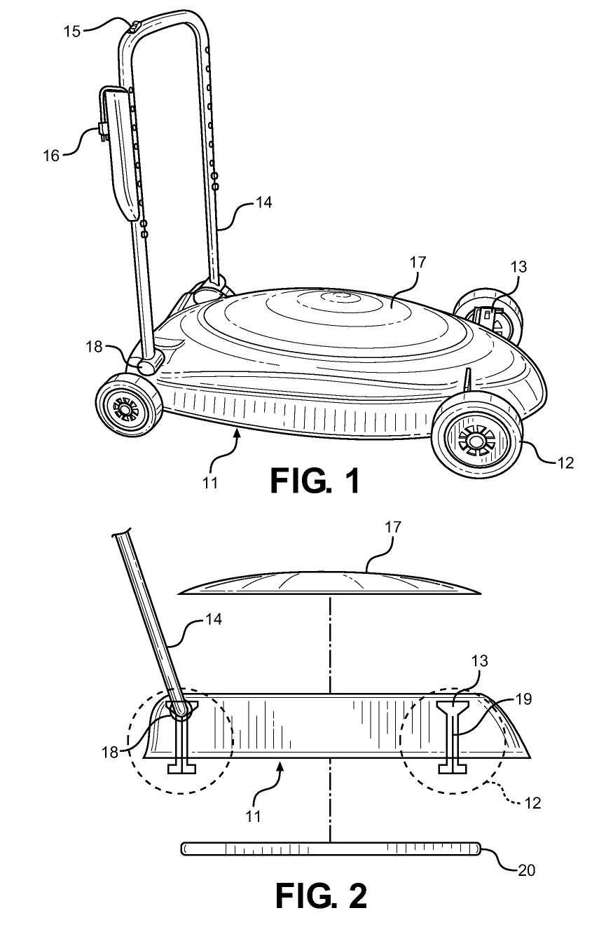

Referring now to FIG. 1, there is shown a perspective view of the present invention, wherein a push-driven frame 11 is provided with a plurality of wheels 12 situated about the corners of the frame 11. Within the frame 11 is an electrically heated plate, control circuitry for controlling the temperature and power distribution to and from the plate, along with a battery pack for supplying onboard power. A U-shaped handle 14 is provided along the backside of the frame 11, which is hingeably attached 18 and telescoping to provide proper ergonomic use by the practitioner. External power may be supplied if the onboard batteries are not fully charged, or are not desired. An extendable power cord 16 is provided along a side of the handle 14, which transmits power from an electrical outlet through the handle 11 and into the frame for transformation and distribution to the heating plate below. A power switch 15 is provided on the topside of the handle 14 for easy user access, allowing the user to readily control the device in the event of an emergency or similar situation.

Along the top side of the frame 11 is an access panel 17, which provides access to the internal electrical connections and battery pack. The panel 17 and sides of the frame 11 are provided an insulative layer to prevent incidental contacts with outside subjects or objects from creating a burning risk. The heat from the heating plate is concentrated out of the base of the frame 11, rather than being conducted through the entire frame assembly.

The height of the frame 11 is controlled by the positioning of the wheels 12 along their respective tracks 13. Each wheel 12 is provided a vertical track 13 from which the height of the wheel axle may be moved along, providing the user the ability to raise and lower the height of the heating plate with regard to the ground surface.

Referring now to FIG. 2, there is shown an exploded side view of the present invention, wherein the frame 11, heating plate 20 and access panel 17 are expanded to show the structure of the device. The heating plate 20 is provided along the bottom surface of the frame 11 in order to minimize the gap between the working surface and the plate 20. The wheel attachments 13 and associated tracks 19 allow each wheel 12 to be adjusted vertically, thereby adjusting the height of each corner of the frame 11.

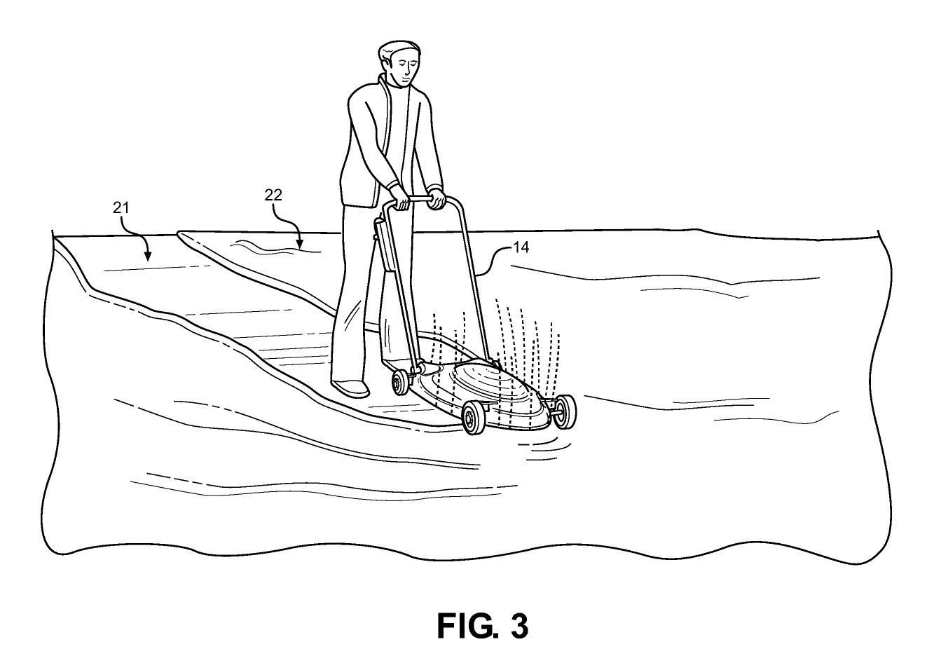

Referring now to FIG. 3, there is shown a view of the present invention in use. The user pushes the device using the supplied handle 14 along a pathway 21 to clear unwanted snow and ice accumulation 22. The high temperature of the electrically heated plate below the frame rapidly melts and vaporizes the snow and ice, creating a clear pathway 21 that is free of slippery ice and snow 22. The temperature of the plate is ideally hot enough to rapidly melt snow and ice to allow the user to slowly push the device without stopping, provided the accumulated snow and ice is not overly thick that it would require prolonged exposure to the heating plate to melt. The gap between the heating plate and the snow and ice is preferably minimized, allowing the plate thermal energy to conduct directly into the snow and ice, as opposed to a convection process. Rock salt may be utilized prior to deployment of the device, as the rock salt is aptly suited for absorbing heat and improving the melting process.

The size of the frame and heating plate is preferably one of three embodiments. The first of which is a large frame and heating plate, provided for clearing large pathways, driveways and parking lots. The second is a push-lawn mower size, similar to FIG. 3, wherein a sidewalk is easily cleared in one pass, or a driveway may be cleared with more passes than the first embodiment. The third embodiment employs a smaller frame, adapted for use along steps, landings, patios and balconies. It is not desired to limit the size of the present invention to a specific set of dimensions, but to provide alternative configurations for different applications.

During cold weather seasons, snow can accumulate in considerable amounts on sidewalks, front steps, and driveways. This poses serious dangers to individuals that must traverse these pathways, as the surfaces may be slick, creating a falling risk created by the snow or ice concealed thereunder. Every year, this situation occurs and results in severe injuries. To prevent this, individuals may choose to shovel the snow off of these high-traffic areas. However, this may require a great deal of physical effort, causing individuals to become tired or develop joint and back pain. Those who have existing back and heart problems may not be able to engage in this activity altogether. Snow blowers may be used in lieu of shovels, but these devices are powered by gas, emit toxic fumes and are loud while in use. A safe, convenient alternative is provided by the present invention, and one that is near silent, is lightweight compared to similar clearing means, provides a method of clearing pathways without physical exertion, and allows the pathways to be cleared without piling the snow in an alternative location. The use of rock salt in combination with the present invention is also a key method of melting snow along a given pathway.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hand-driven, electrically heated device for melting snow and accumulated ice along a pathway, comprising:
a rectangular frame providing an internal oval enclosure and supported by a plurality of wheels situated along corners of said frame;
an internal battery pack, control circuitry and electrically heated plate within said internal enclosure, with access provided thereto by an access panel along said enclosure top surface;
said internal battery pack providing electrical power to said heating plate, and controlled by said control circuitry;
said heated plate positioned along a bottom surface of said enclosure for contact with a working surface;
said wheels attached to said frame by adjustable tracks, wherein height of said frame above said working surface is controlled by said wheel location along said tracks;
a handle projected from said frame and hingeably attached thereto, said frame providing a U-shaped, telescoping structure for a user to push said frame;
an extension cord provided along said handle for optional external power to said heating plate, said extension cord routing through said handle and into said enclosure circuitry.

2) A device as in claim 1, wherein said frame width is sized to fit the width of a step without overhang.

3) A device as in claim 1, wherein said access panel and inner surfaces of said enclosure are insulated to reduce heat transfer to enclosure outer surface, and to concentrate heat said enclosure bottom surface.

4) A method of melting snow and accumulated snow along a pathway, comprising the steps of:
spreading rock salt along a pathway desired to be clear of ice and snow,
pushing a wheeled heating device with an underside heating plate along said salted pathway to utilize said rock salt heat absorption properties to melt snow and ice along said pathway.
